(19) United States
(12) Patent Application Publication
(10) Pub. No.: US 2013/0282582 A1
(43) Pub. Date: Oct. 24, 2013

(54) SYSTEM AND METHOD FOR DATA AND IDENTITY VERFICATION AND AUTHENTICATION

(71) Applicants: EDGARD LOBO BAPTISTA PEREIRA, Sao Paulo (BR); TONY AQUILA, Westlake, TX (US)

(72) Inventors: EDGARD LOBO BAPTISTA PEREIRA, Sao Paulo (BR); TONY AQUILA, Westlake, TX (US)

(21) Appl. No.: 13/865,536

(22) Filed: Apr. 18, 2013

Related U.S. Application Data
(60) Provisional application No. 61/635,260, filed on Apr. 18, 2012.
(60) Provisional application No. 61/696,345, filed on Sep. 4, 2012.
(60) Provisional application No. 61/786,704, filed on Mar. 15, 2013.

(51) Int. Cl. G06Q 20/40

(52) U.S. Cl. CPC G06Q 20/40
USPC 705/44

(57) ABSTRACT

A system for verifying and authenticating the identity of a user in a transaction. The user's identity is authenticated through the user's computer, tablet computer, mobile computing device, web browser (as a web-page, or as a plug-in for the browser), or other computing device by means of a single-use, time sensitive, system-generated transaction token and user selected system PIN. The user presents the transaction token to the vendor or merchant, which forwards a request for authentication to the system. The system prompts the user to confirm the transaction and enter the PIN into the device used to generate the transaction token. Upon confirmation, the transaction is completed.

This application claims benefit of and priority to U.S. Provisional Applications No. 61/635,260, filed Apr. 18, 2012, No. 61/696,345, filed Sep. 4, 2012, and No. 61/786,704, filed Mar. 15, 2013, and entitled to those filing dates for priority, in whole or in part. The specifications, figures and complete disclosures of U.S. Provisional Applications Nos. 61/635,260, 61/696,345, and 61/786,704 are incorporated herein by specific reference for all purposes.

### FIELD OF INVENTION

This invention relates to a system and method for verifying and authenticating the identity of an individual. More specifically, this invention relates to a system and method that that, through the use of a computer, tablet computer, mobile computing device, web browser, or other computing device: (i) simplifies and increases the security of certain financial and other transactions, whether on the Internet, phone, through a call center, via email, or in person; (ii) eliminates the need for username and password on certain financial and other transactions on the Internet; and (iii) verifies and authenticates the identity of an individual.

### BACKGROUND OF THE INVENTION

It is known in the prior art for a user to use a credit card, debit card, or similar mean to purchase an item at a store or on-line. The vendor, whether online or in-person, then typically requests authorization from the issuer of the card, and takes appropriate action based on whether the request is approved or denied.

To prevent fraudulent use of the financial information, the vendor often attempts to ensure the authenticity of the user by use of a security code, identification, or other means. However, such means of authentication can easily be faked, or fraudulently obtained. Accordingly, there is a need for more securely verifying and authenticating the identity of an individual, particularly with regard to a financial transaction.

### SUMMARY OF INVENTION

In various exemplary embodiments, the present invention comprises a system to simplify and increase the security of various transactions on the internet, on the phone, in person, or via email, by authenticating the user's identity through the user's computer, tablet computer, mobile computing device, web browser (as a web-page, or as a plug-in for the browser), or other computing device and then securely providing to the other participants the personal and/or payment information necessary to complete the transaction. The system gathers and stores the user's profile and payment information and authenticates the identity of the individual in subsequent transactions by using a single use, time sensitive, system-generated transaction token, and in some embodiments, a user selected system PIN.

In one embodiment, when integrated with a given website or page on the Internet with which the individual user desires to conduct a transaction or other business, the system authenticates the identity of the individual during the user login and/or purchase transaction processes. In another embodiment, when integrated with a given call center with which the individual user desires to conduct a transaction or other business, the system authenticates the identity of the individual during the purchase transaction process. In yet another embodiment, when integrated with the payment process of a merchant with which the individual user desires to conduct a transaction or other business in person, the system authenticates the identity of the individual during the purchase transaction process.

In various embodiments, after authenticating the individual's identity, the system provides the necessary information that is required to complete the transaction to other commercial participants. The system thereby eliminates the need for the individual user to provide any personal, payment, or valuable information to the merchant with whom he or she wishes to conduct a transaction. All transactions between the system application on the user's computer, tablet computer, mobile computing device, web browser, or other computing device and the system server may be encrypted for security.

In several embodiments, the application on the user's computer, tablet computer, mobile computing device, web browser, or other computing device creates a transaction token on demand. When the user requests a token from the application on the computing device, the application periodically (including, but not limited to, when the application is initiated or started) sends a request to the system server for certain user and non-user specific information. This information may include, but is not limited to, credit card or payment reference identifiers (i.e., identifiers that allow the user to distinguish between payment options, but without the full credit card number or other sensitive information), address reference identifiers (i.e., identifiers that all the user to distinguish between different addresses, but without the full address information), and, in some embodiments, a time stamp. The server then provides the requested information to the system application on the computer, tablet computer, mobile computing device, web browser, or other computing device. That system then develops a single-use, time sensitive transaction token using an algorithm that incorporates the information provided by the system server, a time stamp that is stored on the user's computer, tablet computer, mobile computing device, web browser, or other computing device, and certain information uniquely identifiable with the user's computer, tablet computer, mobile computing device, web browser, or other computing device. Each token must be used within a specified period of time or it becomes invalid.

In several embodiments, the information provided to the website, call center, merchant, or system server, by the user or the system application on the user's computer, tablet computer, mobile computing device, web browser, or other computing device, whether the desired transaction is online, on the phone, or in person, contains no sensitive or valuable information. Therefore, even if the information is intercepted during transmission or subsequently, there is no risk of unauthorized use of the user's personal or payment information. The system also eliminates the need for the user to remember and input website specific usernames and passwords in the case of an Internet transaction.

### BRIEF DESCRIPTION OF THE DRAWINGS

FIG. 1 shows a diagram of a system in accordance with an embodiment of the present invention.

FIG. 2 shows a diagram of an alternative embodiment of the system of FIG. 1.

FIGS. 3-5 show diagrams of additional alternative embodiments of the system of FIG. 1.

FIG. 6 shows another diagram of a system in accordance with another embodiment of the present invention.

FIG. 7 shows another diagram of a system in accordance with another embodiment of the present invention.

FIG. 8 shows a diagram of a login verification system in accordance with another embodiment of the present invention.

### DETAILED DESCRIPTION OF EXEMPLARY EMBODIMENTS

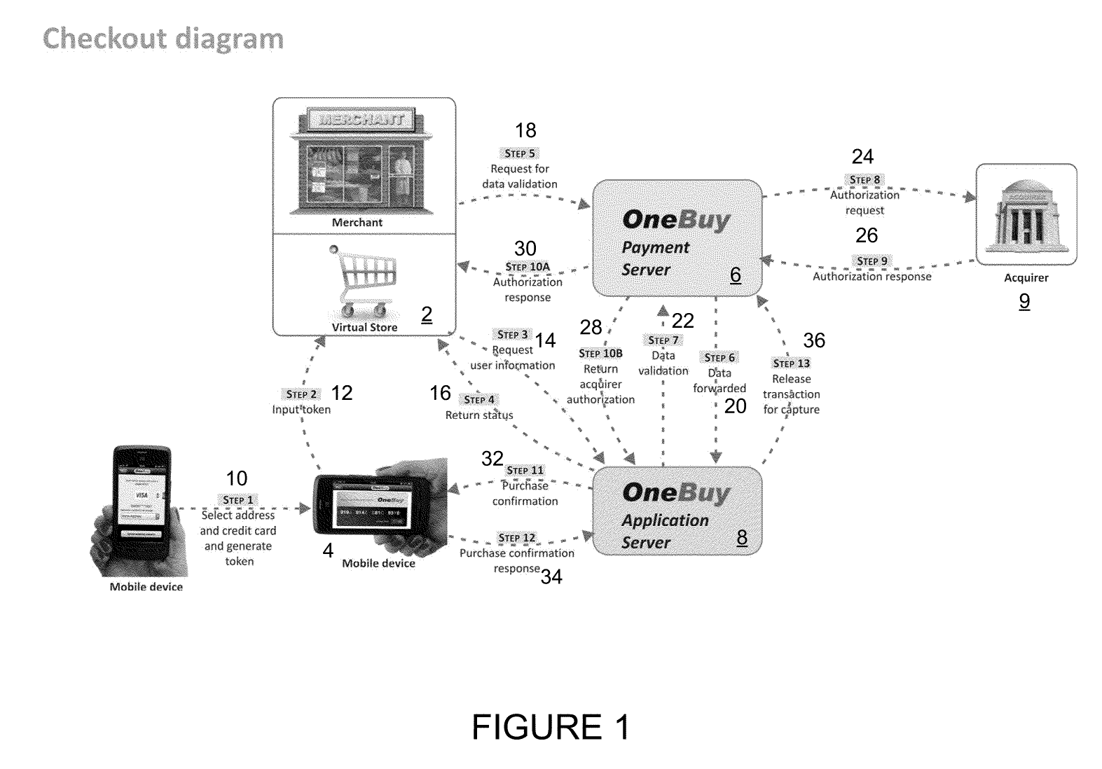

In various exemplary embodiments, as seen in FIGS. 1-8, the present invention comprises a system to simplify and increase the security of various transactions on the internet, on the phone, in person, or via email, by authenticating the user's identity through the user's computer, tablet computer, mobile computing device, web browser (as a web-page, or as a plug-in for the browser), or other computing device and then securely providing to the other participants the personal and/or payment information necessary to complete the transaction. The system gathers and stores the user's profile and payment information and authenticates the identity of the individual in subsequent transactions by using a single use, time sensitive, system-generated transaction token, and, in some embodiments, a user selected system PIN.

In one embodiment, when integrated with a given website or page on the Internet with which the individual user desires to conduct a transaction or other business, the system authenticates the identity of the individual during the user login and/or purchase transaction processes. In another embodiment, when integrated with a given call center with which the individual user desires to conduct a transaction or other business, the system authenticates the identity of the individual during the purchase transaction process. In yet another embodiment, when integrated with the payment process of a merchant with which the individual user desires to conduct a transaction or other business in person, the system authenticates the identity of the individual during the purchase transaction process.

After authenticating the individual's identity, the system provides the necessary information that is required to complete the transaction to other commercial participants. The system thereby eliminates the need for the individual user to provide any personal, payment, or valuable information to the merchant with whom he or she wishes to conduct a transaction. All transactions between the system application on the user's computer, tablet computer, mobile computing device, web browser, or other computing device and the system server may be encrypted for security.

In various embodiments, the system application on the user's computer, tablet computer, mobile computing device, web browser, or other computing device creates a transaction token on demand. When the user requests a token from the system application on the mobile device, the application sends a request to the system server for certain user and non-user specific information, including but not limited to, a time stamp. The server then provides the requested information to the system application on the computer, tablet computer, mobile computing device, web browser, or other computing device. That system then develops a single-use, time sensitive (e.g., expires after a certain period of time) transaction token using an algorithm that incorporates the information provided by the system server, a time stamp that is stored in encrypted form on the user's computer, tablet computer, mobile computing device, web browser, or other computing device, and certain information uniquely identifiable with the user's computer, tablet computer, mobile computing device, web browser, or other computing device. Each token must be used within a specified period of time or it becomes invalid.

The information provided to the website, merchant, or system server, by the user or the system application on the user's computer, tablet computer, mobile computing device, web browser, or other computing device, whether the desired transaction is online, on the phone, or in person, contains no sensitive or valuable information. Therefore, even if the information is intercepted during transmission or subsequently, there is no risk of unauthorized use of the user's personal or payment information. The system also eliminates the need for the user to remember and input website specific usernames and passwords in the case of an Internet transaction.

There are multiple processes, each with variations based upon circumstances, as described below.

During the system user set-up process, the application program is initially downloaded from a system application server 8 and installed on the user's computing device 4. The user selects a user identifier (userID) and password for access to the system application server, and registers with the system. User profile information is gathered and stored. The profile information may include, but is not limited to, the user's name, address or addresses, date of birth, gender, a PIN (personal identification number), and other data elements that might be asked by a merchant, vendor or Internet websites during their user profile set-up processes. In addition, payment method information may be captured and stored, including, but not limited to, credit card, debit card, checking account, and savings account information. More specifically, this information may include, but is not limited to, credit card type, credit card numbers, expiration dates and validation codes, and in some embodiments a credit card reference, which may be selected by the user, to refer to each payment source. User identification is verified during this set-up process by various means. All user information may be updated from time to time. The user's personal information and credit card validation information is stored on a system application server 8, while the credit card numbers are stored on a separate system payment server 6 (which also may be a third-party payment server). The system application causes the userID and a time stamp to be stored in local storage on the computing device 4. The other information described above, including credit card numbers, validation numbers, addresses, and PIN, are not stored locally on the computing device.

In one exemplary embodiment, the profile information also may include one or more loyalty program numbers for the user. These loyalty program numbers may be numbers (or other identifiers) for loyalty program management companies, frequent buyer programs, frequent flyer programs, vendor loyalty or rebate or reward programs, or the like. Typically, the user receives loyalty points or credits (or some similar unit of measure) by making purchases from or at the participating merchant or vendor (e.g., frequent flyer miles can be earned by renting a car from a particular automobile rental company or buying flowers online, in addition to purchasing airfare).

In one embodiment, as seen in FIG. 1, the user has made purchase selections through an online vendor website 2 that has subscribed to or is a member of the system of the present invention. Only merchants who have subscribed to or are members of the system can make use of it, and all member merchants are reviewed and verified before becoming members. When the user is ready to check-out or otherwise complete the transaction, the vendor website presents the user (such as through an icon) the option to complete the transaction using the system of the present invention.

In the case where the user's application program is installed on a mobile phone or computing device separate from the computer accessing the online vendor website, selecting the icon or option causes a small window to open up on the user's computer, asking the user to input the transaction token (which can be any number of digits, but in several exemplary embodiments, comprises a twelve-digit or sixteen-digit numeric or alpha-numeric sequence). The user uses the application program on his or her separate computing device 4 to generate the transaction token. For example, the user will initiate the application program on his or her cell phone, which automatically contacts the system application server 8 and receives payment reference information and address reference information for the user. This reference information does not contain the complete payment information (e.g., credit card number), but is a shorthand reference that has meaning to the user. For example, the payment reference might be the brand of the credit card, plus the last four digits of the credit card number. The address reference might a street name and city name. The application program on the cell phone (or other computing device) then presents the payment reference and address reference information to the user, and asks him or her to select the payment source and shipping address for what is being purchased. After the user makes these selections, the application program generates the transaction token (Step 1) 10. In one particular embodiment, the transaction token is generated by a hash algorithm using the selected payment reference, the selected address reference, the userID, the most recent time stamp stored on the computing device, and computing device's own unique identifier (i.e., the number or code that is unique to each computing device).

In one embodiment, the user also may be presented with a loyalty program reference (e.g., name of the loyalty program), and asked to select the desired loyalty program. This selection may be presented at the same time as the payment reference and address reference selections, or shortly thereafter. Alternatively, the user may have previously designated a default loyalty number (or numbers) to use, and the system thereby may not provide a selection option, or may present a confirmation request to the user. In yet another alternative embodiment, the system may automatically determine and select a loyalty program to use for a particular transaction based on the type of transaction, amount of the transaction, the particular vendor or merchant, previous loyalty programs associated with previous transactions, user-indicated preferences, or other similar factors. However determined, the loyalty program information, if any, is included in the information sent to the vendor/merchant (as described below), and may also be directly sent, along with any necessary transaction information (e.g., amount of purchase), to the appropriate loyalty program management company or manager, as appropriate.

In another exemplary embodiment, when presenting the payment reference, the system may indicate or recommend a particular payment source as “optimal,” “recommended,” or “preferred.” This determination may be based on a variety of factors relating to the user, the payment sources, and the vendors or merchants. Factors may include, but are not limited to, interest rates (e.g., credit cards with lower interest rates may be preferred); payment due dates; time to pay without interest; participation in a bonus point, rebate, or similar program; credit limit; remaining credit; transaction or bank interchange fees; volume discounts; volume incentives; credit scores, and the like. Only one factor may be used, or a combination of factors. In one embodiment, several factors may be weighted. In yet a further embodiment, credit scores for the user are obtained periodically (e.g., quarterly). In an alternative embodiment, the user may elect to have the system automatically determine and use the “optimal” payment source determined as above. This optimal payment source may be presented to the user for confirmation.

The user then inputs the transaction token into the system window (Step 2) 12, and the token is then sent to the system application server 8 to request information and for processing (Step 3) 14. In the alternative case where the application program is installed on the same computing device as used for the transaction, selecting the icon or option to use the system for completing the transaction causes the transaction token to be generated by the installed application program, and send the transactions token to the system application server for processing directly, without needing the user to input the transaction token. Alternatively, the application server can generate the transaction token. The application server decrypts and authenticates the transaction token to identify the user and selected address and payment method, then sends to the vendor the transaction token, the user shipping information and the payment source type and identifier (e.g., the name of the credit card and the last four digits of the credit card number) (Step 4) 16. The vendor then sends a request for validation (Step 5) 18 to the system payment server 6, the request including, but not limited to, transaction information (e.g., amount of the transaction, shipping address, last four digits of credit card, type of credit card) and the transaction token. The payment server 6 forwards the transaction token and transaction information (Step 6) 20 to the system application server 8 for validation. The application server validates the information provided, and returns a data validation (Step 7) 22 comprising an identifier for the payment source that allows the payment server to retrieve the entire payment source information (e.g., full credit card number), and also comprising any additional authorization codes (e.g., the three-digit credit card reference code).

The payment server 6 then seeks and obtains authorization from the payment source issuer 9 (e.g., credit card issuer), according to methods that are known in the art (Steps 8, 9) 24, 26. When authorization is received from the issuer, the payment server forwards the authorization (Step 10B) 28 to the application server (and in some embodiments, also to the vendor (Step 10A) 30). The application server then sends a message (Step 11) 32 containing the transaction information to the user's computing device 4 with the application program used to generate the transaction token, asking the user to confirm the transaction. For example, the message presented to the user may state: “Do you confirm the purchase at Vendor X in the amount of $X using your credit card xxxx-xxxx-xxxx-NNNN to be shipped to X address?” To confirm, the user selects “yes” or “confirm.” In one embodiment, the user is then prompted to enter their PIN. The confirmation and PIN are sent back (Step 12) 34 to the application server, which validates the PIN. If the PIN is incorrect, the user may be prompted to re-enter the PIN (in one embodiment, the user is given three chances to enter the correct PIN, after which the transaction is automatically canceled). Likewise, if the user declines to confirm, the transaction is canceled.

After the application server validates the confirmation, it confirms (Step 13) 36 the transaction with the payment server, which proceeds to complete the transaction according to the transaction capture methods known in the art. The vendor is notified of the confirmation and completion, and the transaction completed.

The system of FIG. 1 also can be used for transactions conducted through call-centers, email, or physical stories. For a call-center transaction, the user generates a transaction token and reads it to the call-center operator, who inputs it into the vendor's system. For an email transaction, an offer sent via email would include a system icon or entry field/window for entry of a transaction token. The user generates a transaction token, and inputs it into the window, thereby avoiding the need to be taken to a possibly fraudulent website or inputting credit card or other personal information. For a physical transaction, the user generates a transaction token, and can read it to the point-of-sale clerk, generate a QR or bar code with the transaction token for scanning at the point-of-sale, electronically communicate the transaction token directly to the point-of-sale terminal, or use any other means known in the art to communicate the transaction code to the vendor.

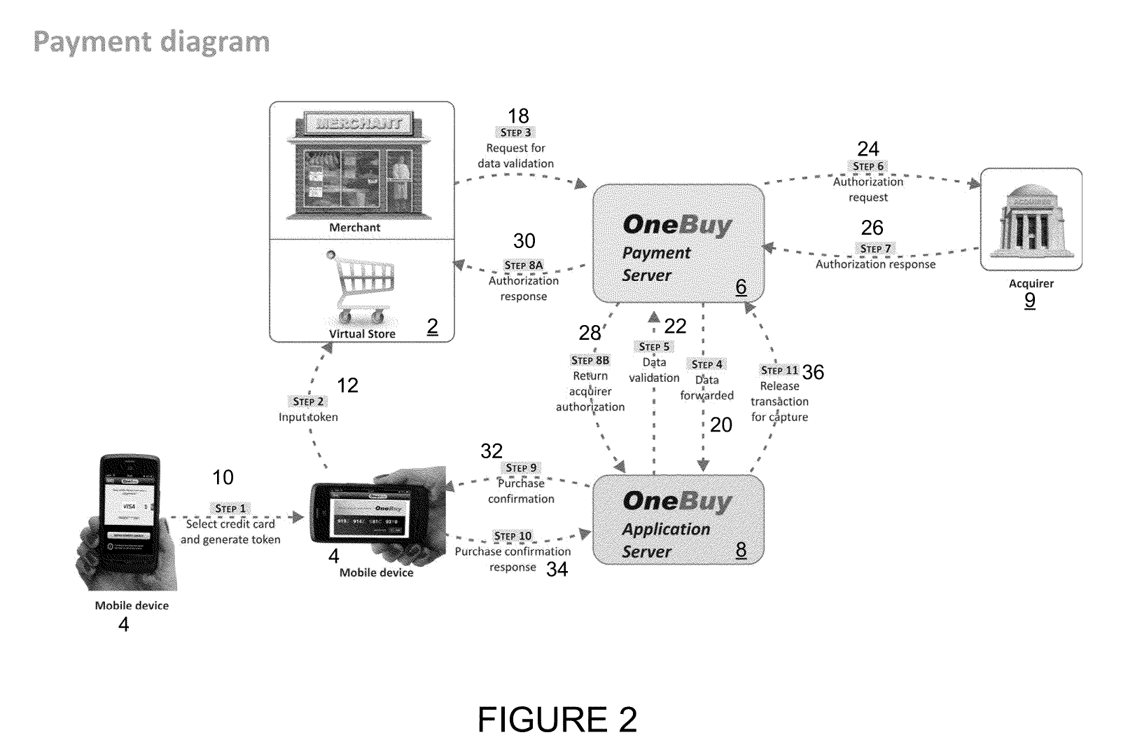

FIG. 2 shows an alternative embodiment of the present invention without the steps of requesting and returning user information between the application server and the vendor site (such as when the user already has an account with the vendor or the user information is already known by the vendor). It is otherwise similar to the process described above with regard to FIG. 1.

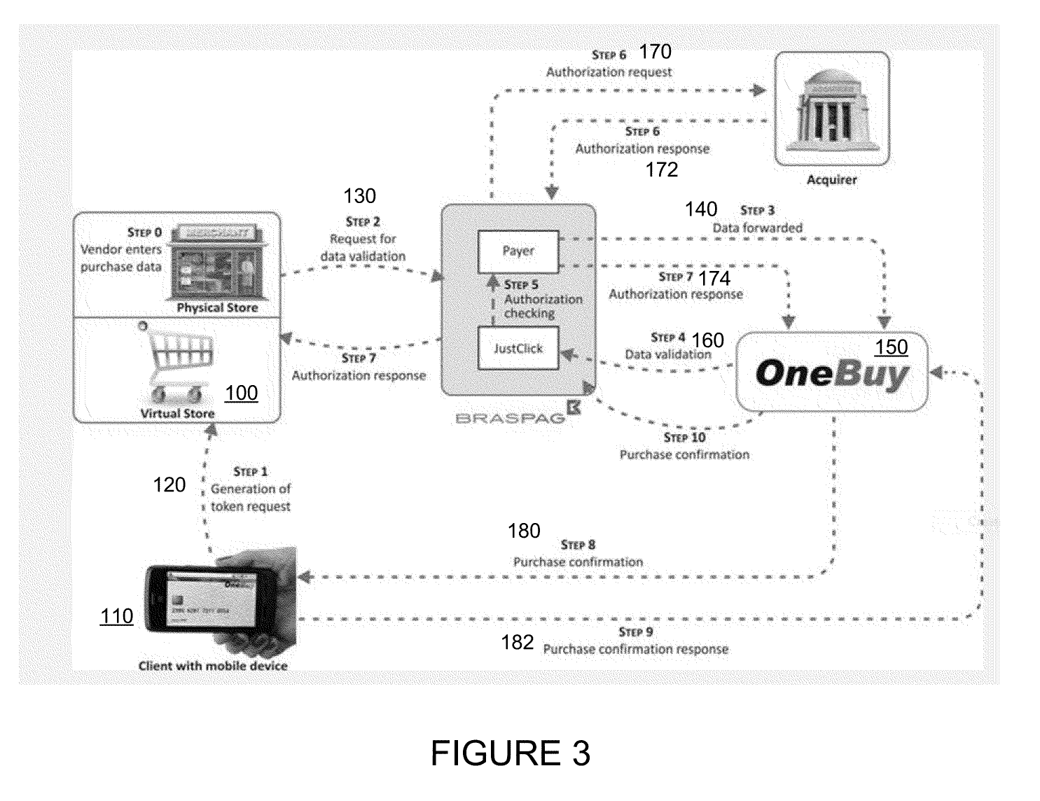

Yet another alternative embodiment is shown in FIG. 3. When the user is ready to complete the transaction 100, the user generates the token request 120 with his or her computing device 110. The transaction data and token are sent as part of the request for data validation 130 to a transaction verification entity. The transaction verification entity forwards the data 140 to the system application server 150, which returns a validation of the data 160. The transaction verification entity then seeks authorization 170 from the financial entity (e.g., credit card company, bank, or the like), and receives authorization therefrom 172. This response is forwarded 174 to the system application server 150, which sends a purchase confirmation request 180 to the user. Upon confirmation 182 by the user, the transaction is authorized and completed by the vendor.

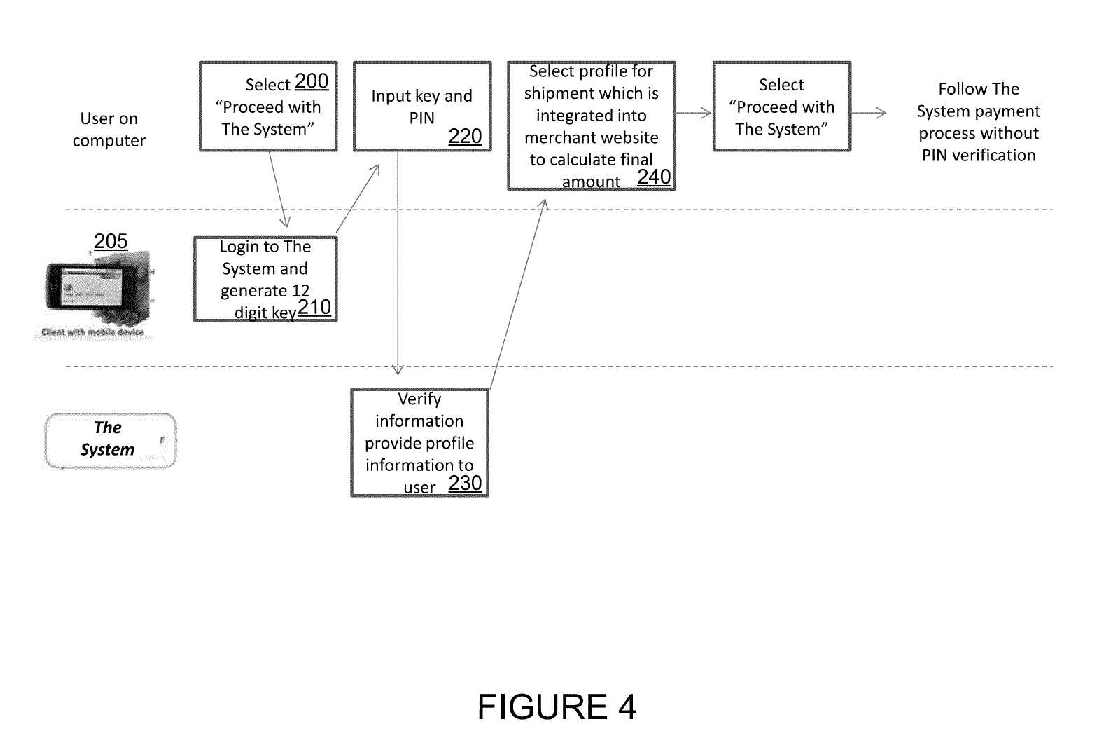

For a given website that has integrated the system, the user can log in to the website directly or, alternatively, may use the system of the present invention to log into the website. In the latter case, this eliminates the need for the user to remember his or her username and password for that website, and the need for separate authentication of the identification of the user by the website. As seen in FIG. 4, if the user chooses to proceed using the system 200, he or she logins using the system and requests a transaction token (described above) 210 using the system application on his or her computer, tablet computer, mobile computing device, web browser, or other computing device 205. The system then generates a single-use, time sensitive, transaction token 210 in accordance with the process set forth above and presents it to the user. The user inputs the token into the website, and enters his or her PIN as well 220. The website then sends a request to the system server to confirm that the token is from a registered user of that website 230. The system server determines whether the token was received from a registered member of the website and communicates the answer to the website and the user login process is completed. Profile information for the user also may be provided to the user 230. The user can then select the profile information, which includes shipping data, for providing to the merchant or vendor 240.

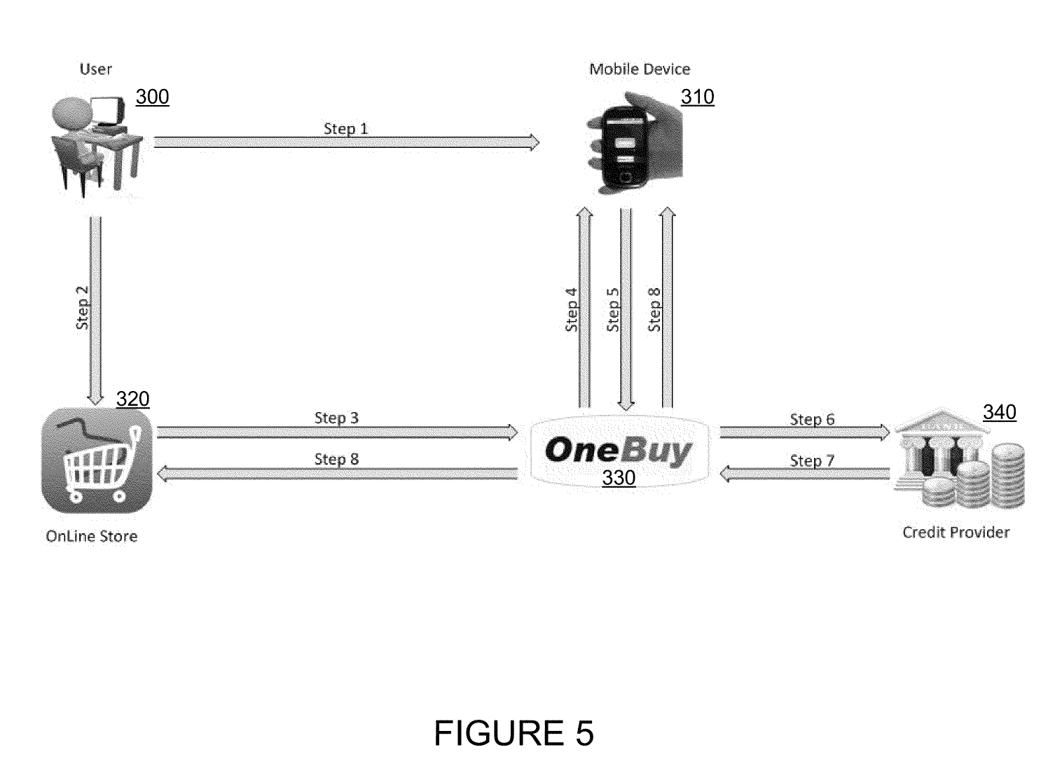

FIG. 5 shows a variation of the system where user 300 uses his or her computing device 310 to generate the token (step 1), which is submitted (step 2) to an online store website 320, which forwards (step 3) the data directly to the system 330, which first seeks confirmation (steps 4, 5) from the user through the computing device 310, then seeks authorization (steps 6,7) from the credit provider or financial institution 340, before sending final authorization notice (step 8) to the vendor 320 and the user's computing device 310.

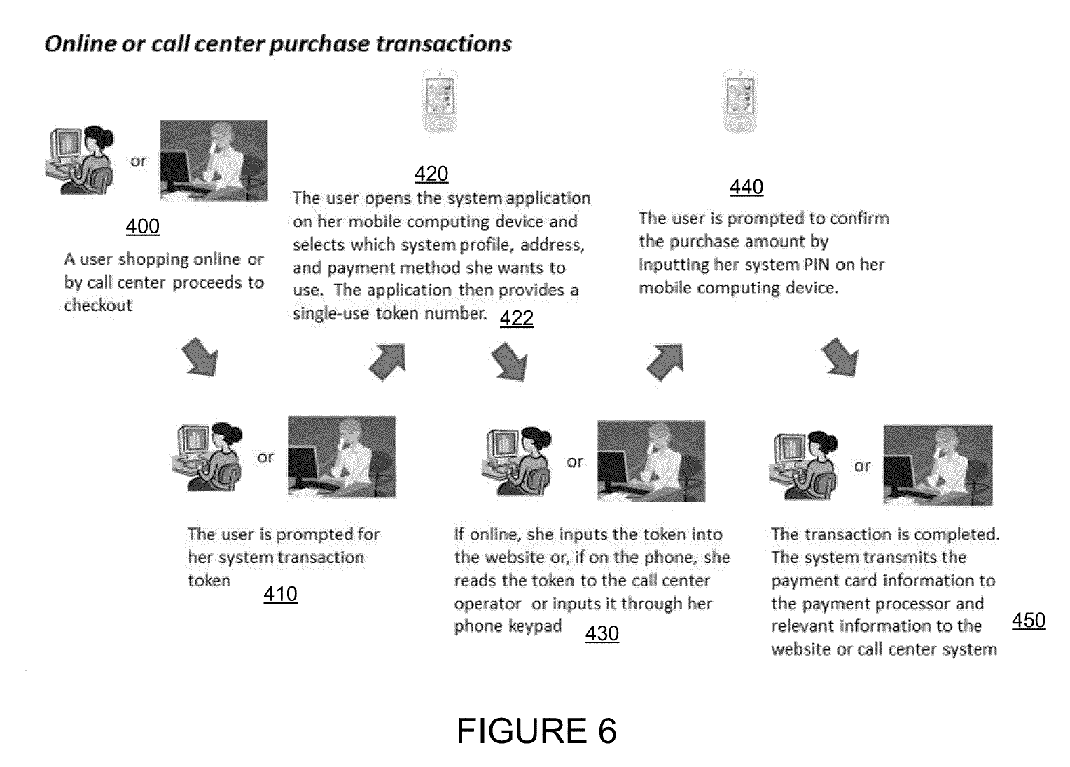

During a purchase transaction on a website that has integrated the system, or through a call center 400, as seen in FIG. 6, the user is prompted for, and provides, his or her system transaction token 410. The user then may use the system to input user profile, shipping address, and payment information, or solely the payment information 420. Rather than having to input all of this information, which can sometimes be twenty or more separate data entry fields, the user can have the system provide it automatically to the website. When prompted by the website, the user simply chooses to have the system provide the required information. Then, using the system on his computer, tablet computer, mobile computing device, web browser, or other computing device, the user selects from pre-stored options the user profile and shipping information he wishes to send to the website, and payment method he wishes to use for the transaction.

The system then generates a single-use, time sensitive, transaction token 422 in accordance with the process set forth above and presents it to the user. The user inputs the token into the website 430. The website then sends information to the system server, including, but not limited to, certain transaction information and the transaction token. The system server then sends a message, which includes without limitation some or all of the information provided by the website, to the system application on the computer, tablet computer, mobile computing device, web browser, or other computing device that is uniquely compatible with the transaction token, prompting the user to confirm the purchase 440. Using the system application on his or her computing device, the user then reviews the information provided by the system server, either confirms or denies the transaction, and enters his system PIN 440. The system application on the user's computing device then reviews the information and determines whether the system PIN is correct.

In one exemplary embodiment, the system then develops a second single-use, time sensitive transaction token containing information, including but not limited to, whether the transaction is confirmed or denied and sends it to the system server. The system server then decodes this second token and determines whether the transaction is confirmed or denied. The transaction will be confirmed only if the user confirms it and inputs the correct PIN 450. The transaction is denied if either the user denies it or he or she inputs the incorrect PIN. If the transaction is confirmed, then the system server sends (i) information to the merchant, including but not limited to, transaction confirmation and the requested user profile and shipping address information, and (ii) payment information to the payment processor. If the transaction is denied, then the system server sends information to the merchant, including but not limited to the transaction denial and the reason for the denial. During this process, if the user wishes, the system can conceal all of the user's personal and payment information from the integrated website. This heightened level of confidentiality increases the security of the user's personal and financial information and enables the user to make purchases without disclosing his personal or financial information to the website.

The system also provides increased security and simplifies call center transactions. In one embodiment of the system, during a purchase transaction with a call center that has integrated the system, the user may use the system to input user profile, shipping address, and payment information, or solely payment information. When offered, the user chooses to check out using the system. In this case, rather than asking for name, address, and payment information, the call center operator will ask only for a system transaction token. The user obtains a transaction token from the system application on his mobile device in the same manner as outlined above for like Internet transactions and reads the number to the operator or, in some configurations, uses his phone keypad to enter the number. The authentication and verification process is the same as for like Internet transactions except that rather than communicating with an integrated website, the system server communicates with the integrated call center's system. This process simplifies the phone call, reduces the possibility of data input error, and increases personal and payment information security—no valuable or reusable information is shared with the call center operator.

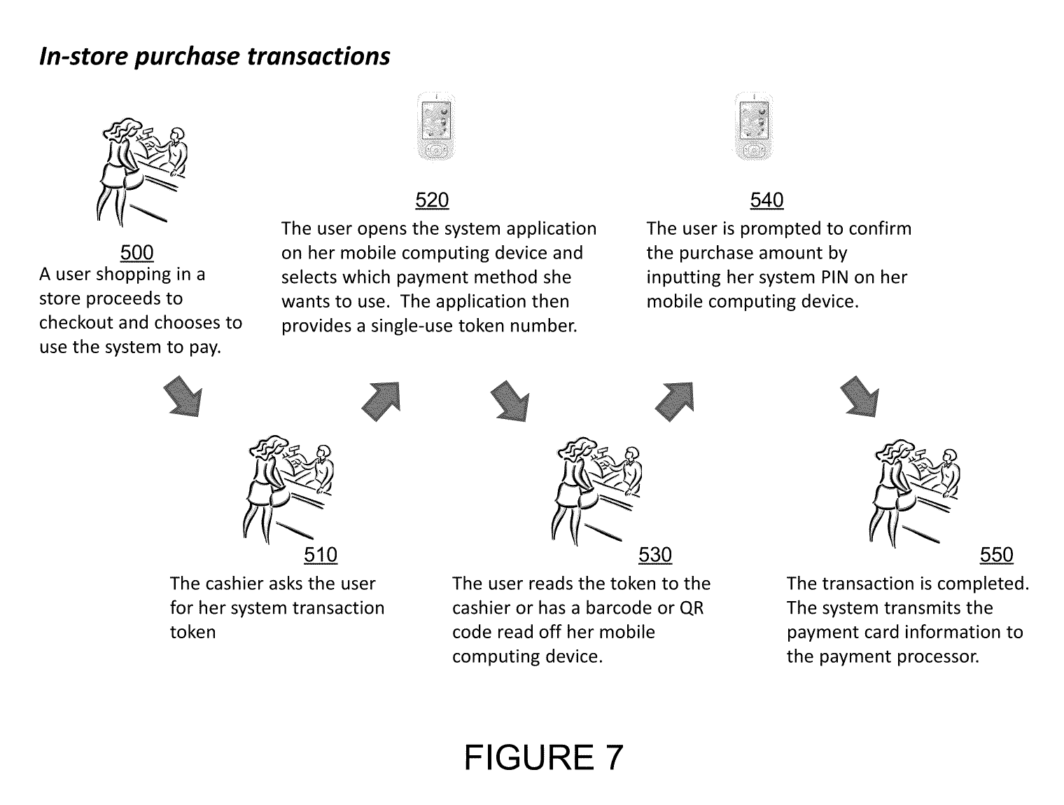

The system may also be used to simplify and increase security for in person, or in store, purchase transactions. In one embodiment of the system, as seen in FIG. 7, when a user is at checkout in a store integrated with the system, when offered the choice, he selects to checkout using the system 500. He is then asked for a transaction token 510. The user obtains 520 a transaction token from the system application on his mobile or computing device in the same manner as outlined above for like Internet transactions, and reads the number to the cashier or, in some configurations, he may have a barcode or QR code, generated by the system application on his mobile or computing device, on his mobile or computing device scanned by an in-store scanning device 530. The authentication and verification process 540 is the same as for like Internet transactions except that rather than communicating with an integrated website, the system server communicates with the integrated store's system for cardholder verification. This process reduces the probability of fraud by improving cardholder verification and reduces the likelihood of stolen identity by eliminating the disclosure of payment information at the point of sale. Upon cardholder verification, the system transmits the payment information to the payment processor 550.

In yet another embodiment, a transaction may be initiated by an email from a merchant or vendor to a potential customer. The email would include a window or other prompt or link to cause the recipient to use the system of the present invention. The recipient obtains a transaction token on his or her computer, tablet computer, mobile computing device, web browser, or other computing device in the same manner as outlined above, and enters it in the window, or on a linked page. The authentication and verification process is the same as for like Internet transactions. This method allows a user to securely respond to an email offer while avoiding phishing or other forms of Internet or email fraud.

In one embodiment of the system, payment transactions from multiple individual users may be tracked and reported upon as members of a larger group account, enabling an administrator of the group account to monitor and control the transaction activities of the individual members.

Further, in one embodiment the system uses metrics, including but not limited to credit score, to determine the optimal method of payment of the user's registered settlement options inputted into the system. The system also provides regular reporting to participants in the process, including but not limited to the user and the merchant, of the user's relevant transaction activity.

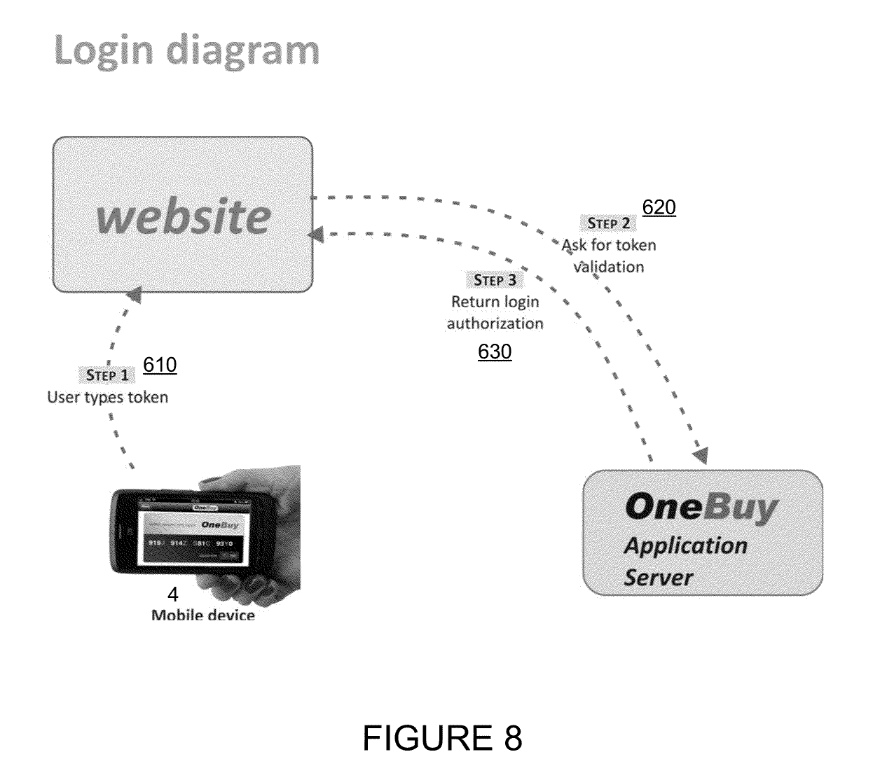

In yet another embodiment, as seen in FIG. 8, the system may be used as a login verification system for a user to log into the online user area for the system of the present invention, or for any online website, online service, social network, or the like. To log in, the user generates a token based on the most recent time stamp, userID, and computing device identifier (since the token is not associated with a particular transaction, there is no need for a payment source reference or address reference, as described above). Instead of typing a user name and password to access the online service or website, the user types just the token (Step 1) 610. The website then sends the token to the application server for validation (Step 2) 620. Upon validation, the application server returns a login authorization to the website (Step 3) 630. In one exemplary embodiment, the application server also may send a message to the user's computing device asking the user to confirm that he or she is seeking to log into the website. The user can confirm in the same manner as discussed above with regard to a transaction.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A computer-based method of identity authentication for a transaction, comprising:
receiving, using a processor or microprocessor in a computing device, a request from a user to generate a transaction token for use in a transaction;
generating, using a processor or microprocessor, the transaction token;
displaying the transaction token to the user;
receiving a request to verify a transaction from a remote verification system;
prompting the user to input a personal identification number or code to confirm the transaction; and
sending the personal identification number or code to the remote verification system to confirm the transaction.

2. The method of claim 1, wherein the computing device is a personal computer, a smart phone, or mobile computing device.

3. The method of claim 1, wherein the transaction is an online commercial transaction, or a commercial transaction initiated through an email.

4. The method of claim 1, wherein the transaction is a commercial transaction conducted through a call center.

5. The method of claim 1, wherein the transaction is a commercial transaction conducted in a store.

6. The method of claim 1, wherein the transaction token is single-use.

7. The method of claim 1, wherein the transaction token is time sensitive.

8. The method of claim 1, wherein the transaction token is displayed as a barcode or QR code.

9. The method of claim 1, wherein the transaction code is displayed as a numeric or alpha-numeric sequence of twelve or more digits.

10. The method of claim 1, further comprising the step of prompting the user to select a payment source reference and a shipping address reference for the transaction.

11. The method of claim 10, wherein the transaction token is generated based on, at least in part, a time stamp previously installed on the computing device, the computing device's own unique identification code or number, the payment source reference source selected by the user, and the shipping address reference selected by the user.

12. The method of claim 10, further comprising the step of prompting the user to select a loyalty program reference for the transaction.

13. The method of claim 10, wherein the step of prompting the user to select a payment source reference further comprises the step of:
automatically determining a preferred or optimal payment source; and
presenting a list of one or more payment source references to the user, wherein the payment source reference corresponding to the preferred or optimal payment source is indicated as being preferred or optimal.

14. A computer-based method of identity authentication for a transaction, comprising:
receiving, using a processor or microprocessor, a request to authorize a transaction between a merchant or vendor and an individual, said request comprising transaction data and a single-use, time-sensitive transaction token;
processing the transaction token to determine the identity of the individual;
sending, using a processor or microprocessor, a request to a computing device of the individual to prompt the individual to authorize the transaction, wherein the computing device is the computing device used to generate the transaction token;
receiving from the computing device of the individual an affirmation to proceed with the transaction and a personal identification number or code; and
verifying that the personal identification number or code is correct.

15. The method of claim 14, further comprising the step of sending an authorization of the transaction to a payment processor or the merchant or vendor.

16. The method of claim 14, wherein the computing device is a personal computer, a smart phone or mobile computing device.

17. The method of claim 14, wherein the transaction is an online commercial transaction, or a commercial transaction initiated through an email.

18. The method of claim 14, wherein the transaction is a commercial transaction conducted through a call center.

19. The method of claim 14, wherein the transaction is a commercial transaction conducted in a store.
